(19) United States
(12) Patent Application Publication
(10) Pub. No.: US 2025/0200131 A1
(43) Pub. Date: Jun. 19, 2025

(54) SOLVING DEVICE AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventors: Shunji TESHIMA, Inagi Tokyo (JP); Kotaro ENDO, Shinjuku Tokyo (JP); Yasuichiro IZUMI, Fuchu Tokyo (JP); Masaru SUZUKI, Ota Tokyo (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 19/066,529

(22) Filed: Feb. 28, 2025

Related U.S. Application Data
(63) Continuation of application No. PCT/JP2023/024728, filed on Jul. 4, 2023.

(30) Foreign Application Priority Data
Feb. 18, 2022 (JP) 2022-023657

(51) Int. Cl. G06F 17/11

(52) U.S. Cl. CPC G06F 17/11

(57) ABSTRACT

A solving device includes a multiplier-updating unit and an augmented-Lagrange-solving unit. The multiplier-updating unit updates M Lagrange multipliers and M penalty multipliers included in an augmented Lagrange function based on an objective function and M linear equations. The augmented-Lagrange-solving unit calculates a solution to a problem of minimizing an augmented Lagrange function including M Lagrange multipliers and M penalty multipliers updated each time the update processing is performed. The augmented-Lagrange-solving unit alternately updates first variables and second variables sequentially for each unit time from an initial-time to an end-time for each of N particles with which the first variables and the second variables are associated, respectively. In the update processing for each unit time, the augmented-Lagrange-solving unit updates the first variable based on the second variable for each of the N particles, and updates the second variable based on the first variable and a constraint term.

### CROSS-REFERENCE TO RELATED APPLICATIONS

This application is a continuation of International Application No. PCT/JP2023/024728 filed on Jul. 4, 2023 based on JP Application 2022-023657 filed on Feb. 18, 2022, the entire contents of which are incorporated herein by reference.

### FIELD

Embodiments described herein relate generally to a solving device and a computer program product.

### BACKGROUND

There is a demand for solving an Ising problem under a linear equality constraint. As a method for solving such a problem, an augmented Lagrange method is known. The augmented Lagrange method is a method in which an Ising problem is acquired under a linear equality constraint by iteratively calculating a solution to a problem of minimizing an augmented Lagrange function while changing a Lagrange multiplier (λ) and a penalty multiplier (μ).

When solving a problem of minimizing an augmented Lagrange function, the way to approach is finding a new Ising problem that is equal to a function obtained by adding a constant to the augmented Lagrange function and solving the new Ising problem by an Ising machine.

However, the processing of finding a new Ising problem is time-consuming to deform the equation, and requires a large amount of calculations. As such, there is a demand for efficiently solving an Ising problem under a linear equality constraint without such equation deformation.

### BRIEF DESCRIPTION OF THE DRAWINGS

FIG. 1 is a diagram illustrating a functional configuration of a solving device according to the present embodiment.

FIG. 2 is a flowchart illustrating a flow of a process performed by the solving device.

FIG. 3 is a diagram illustrating a functional configuration of an augmented Lagrange solving unit.

FIG. 4 is a flowchart illustrating a first example of a flow of a process performed by a variable updating unit.

FIG. 5 is a flowchart illustrating a second example of a flow of a process performed by a variable updating unit.

FIG. 6 is a diagram illustrating a hardware configuration of the solving device.

### DETAILED DESCRIPTION

The object of the present disclosure is to efficiently solve an Ising problem under a linear equality constraint.

A solving device according to an embodiment solves an Ising problem under a linear equality constraint represented by M linear equations (M is an integer of 1 or more) using N Ising spins (N is an integer of 2 or more) included in the Ising problem. The solving device includes an input unit, a multiplier updating unit, an augmented Lagrange solving unit, and an output unit. The input unit receives an objective function of the Ising problem and the M linear equations. The multiplier updating unit repeats update processing of updating M Lagrange multipliers and M penalty multipliers included in an augmented Lagrange function based on the objective function and the M linear equations. The augmented Lagrange solving unit calculates a solution to a problem of minimizing the augmented Lagrange function including the M Lagrange multipliers and the M penalty multipliers updated each time the update processing is performed. The output unit outputs a solution to a problem of minimizing the augmented Lagrange function after the update processing is repeated until a preset end condition is reached, as a solution obtained by solving the Ising problem under the linear equality constraint. The augmented Lagrange solving unit includes a variable updating unit and a solution output unit. The variable updating unit alternately updates first variables and second variables sequentially for each unit time from an initial time to an end time for each of N virtual particles with which the first variables and the second variables are associated, respectively. The solution output unit outputs a solution to a problem of minimizing the augmented Lagrange function based on the respective first variables of the N particles at the end time. The N particles correspond to the N Ising spins. In the update processing for the each unit time, the variable updating unit updates the first variable based on the second variable for each of the N particles; and updates the second variable based on the first variable and a constraint term for each of the N particles.

Hereinafter, a solving device 10 according to an embodiment will be described with reference to the drawings. The solving device 10 according to the present embodiment solves an Ising problem under a linear equality constraint using an augmented Lagrange method.

### Ising Problem

An N-size Ising problem is a problem of calculating a spin arrangement that minimizes Ising energy for an Ising model including N Ising spins (N is an integer of 2 or more). That is, the N-size Ising problem is a problem of minimizing an objective function expressed by a quadratic function of N Ising spins. Specifically, the Ising problem is expressed as Formula (1).

$${min}_{s ∈ {[ - 1 , 1 ]}^{N}} - \frac{1}{2} {\sum }_{i = 1}^{N} {\sum }_{j = 1}^{N} {J}_{i , j} {s}_{i} {s}_{j} + {\sum }_{i = 1}^{N} {h}_{i} {s}_{i} \qquad ( 1 )$$

sᵢ and sⱼ represent Ising spins, and are binary variables representing −1 or 1. sᵢ represents an i-th Ising spin (i is an arbitrary integer greater than or equal to 1 and smaller than or equal to N) among the N Ising spins. sⱼ represents a j-th Ising spin (j is an arbitrary integer greater than or equal to 1 and smaller than or equal to N) among the N Ising spins.

J_{i,j} is a coupling coefficient multiplied by a quadratic term including the i-th Ising spin and the j-th Ising spin in the objective function. In addition, J represents a matrix including N×N coupling coefficients, and is called an interaction matrix. In J, J_{i,j} is located in an i-th row and a j-th column.

hᵢ is an external magnetic field coefficient multiplied by a linear term including the i-th Ising spin in the objective function. In addition, h represents a vector including N external magnetic field coefficients in which hᵢ is arranged at an i-th external magnetic field coefficient, and is called an external magnetic field vector.

A device used to solve the Ising problem is called an Ising machine. The Ising machine receives J and h as a problem to be solved, and searches for a spin arrangement with lower Ising energy. The Ising machine outputs, as a solution, a spin arrangement representing values of N Ising spins obtained through the search. The spin arrangement with the minimum Ising energy is called a strict solution. The Ising machine may output a spin arrangement that is not a strict solution but has Ising energy close to the minimum Ising energy.

A 0-1 combination optimization problem having a quadratic function of a binary variable in a bit format taking a value of either 0 or 1 as an objective function is called a 0-1 quadratic programming problem. The binary variable in the bit format is converted into an Ising spin by using a calculation of (1+s)/2. That is, the 0-1 quadratic programming problem can be said to be equivalent to the Ising problem represented by Formula (1). Therefore, the 0-1 quadratic programming problem can be converted into an Ising problem, and a solution can be calculated by the Ising machine.

### SB Algorithm

A simulated bifurcation algorithm (SB algorithm) as one of the algorithms for solving an Ising problem is described in JP 2019-145010 A, Non Patent Literature “Hayato Goto, Kosuke Tatsumura, Alexander R. Dixon, “Combinatorial optimization by simulating adiabatic bifurcations in nonlinear Hamiltonian systems”, Science Advances, vol. 5, no. 4, eaav2372, 19 Apr. 2019”, and Non Patent Literature “Hayato Goto, Kotaro Endo, Masaru Suzuki, Yoshisato Sakai, Taro Kanao, Yohei Hamakawa, Ryo Hidaka, Masaya Yamasaki, and Kosuke Tatsumura, “High-performance combinatorial optimization based on classical mechanics”, Science Advances 7, 6 (2021), eabe7953”.

The SB algorithm solves the Ising problem by simulating a time evolution of a Hamiltonian in which virtual N particles are separated into two positions over time. In particular, the SB algorithm simulates the time evolution of N particles, using equations of motion in which the calculation of the interaction matrix is included only in the equation for calculating momentum, and the calculation of the interaction matrix is not in the equation for calculating position. For this reason, the SB algorithm can simulate the time evolution of the Hamiltonian using a discrete solution of a symplectic Euler method or the like. Therefore, the SB algorithm can obtain a solution at a high speed with a small calculation cost.

The N particles correspond to N Ising spins in the Ising problem. The SB algorithm uses N variables xᵢ and N variables yᵢ corresponding to the N particles. Each of the N variables xᵢ represents a position of an i-th particle among the N particles. Each of the N variables yᵢ represents momentum of the i-th particle. The variable xᵢ is also called a first variable, and the variable yᵢ is also called a second variable.

The SB algorithm uses equations of motion represented by Formulas (2-1) and (2-2).

$$\frac{{dx}_{i}}{dt} = \frac{\partial {H}_{SBM}}{\partial {y}_{i}} = {Dy}_{i} \qquad ( 2 - 1 )$$

$$\frac{{dy}_{i}}{dt} = - \frac{\partial {H}_{SBM}}{\partial {x}_{i}} = ( p - D - {Kx}_{i}^{2} ) {x}_{i} - {ch}_{i} a + c {\sum }_{j = 1}^{N} {J}_{i , j} {x}_{j} \qquad ( 2 - 2 )$$

t is a variable representing a time. D is a predetermined constant and corresponds to detuning. p corresponds to a pumping amplitude, and is a value that monotonically increases according to the number of updates during the calculation of the SB algorithm. The initial value of p may be set to 0. K is a predetermined constant and corresponds to a positive Kerr coefficient. Note that K may be 0. c is a predetermined value. a may be a predetermined value, or a value that changes according to the number of updates during the calculation of the SB algorithm.

H_{SBM} represents a Hamiltonian, and is represented by Formula (3).

$${H}_{SBM} = {\sum }_{i = 1}^{N} ( \frac{( D - p ) {x}_{i}^{2}}{2} + \frac{{Kx}_{i}^{4}}{4} + \frac{{Dy}_{i}^{2}}{2} ) + c [ - \frac{1}{2} {\sum }_{i = 1}^{N} {\sum }_{j = 1}^{N} {J}_{i , j} {x}_{i} {x}_{j} + {\sum }_{i = 1}^{N} {h}_{i} {x}_{i} a ] \qquad ( 3 )$$

The SB algorithm simulates the time evolution of the equations of motion shown in Formulas (2-1) and (2-2), for example, using a discrete solution of the symplectic Euler method. In this case, the SB algorithm alternately repeats calculations of Formula (4-1) and Formula (4-2).

$${x}_{i} = {x}_{i} + {Dy}_{i} dt \qquad ( 4 - 1 )$$

$${y}_{i} = {y}_{i} + \{ ( p - D - {Kx}_{i}^{2} ) {x}_{i} - {ch}_{i} a + c {\sum }_{j = 1}^{N} {J}_{i , j} {x}_{j} \} dt \qquad ( 4 - 2 )$$

Then, the SB algorithm binarizes each of the values of the N variables xᵢ when a predetermined number of iterations is reached to −1 or 1 using a predetermined threshold (e.g., 0), and outputs the binarized result as a solution of the Ising problem.

Note that the SB algorithm has several variations. For example, “High-performance combinatorial optimization based on classical mechanics” describes a ballistic SB (bSB) algorithm and a discrete SB (dSB) algorithm. Both the ballistic SB algorithm and the discrete SB algorithm alternately repeat xᵢ and yᵢ while increasing t by Δt to simulate the time evolution of the equations of motion. Meanwhile, each time xᵢ is updated, the ballistic SB algorithm changes xᵢ to −1 and yᵢ to 0 if xᵢ is smaller than −1, and changes xᵢ to 1 and yᵢ to 0 if xᵢ is greater than 1. In addition, each time xᵢ is updated, the discrete SB algorithm changes the value of xᵢ to −1 or 1 depending on whether the value of xᵢ is smaller than 0. In addition, the ballistic SB algorithm and the discrete SB algorithm are different in the calculation of the part (p−D−Kxᵢ²)xᵢ in Formula (2-2).

### Ising Problem Under Linear Equality Constraint

The Ising problem under a linear equality constraint is expressed as Formulas (5-1) and (5-2).

$${min}_{s ∈ {[ - 1 , 1 ]}^{N}} - \frac{1}{2} {\sum }_{i = 1}^{N} {\sum }_{j = 1}^{N} {J}_{i , j} {s}_{i} {s}_{j} + {\sum }_{i = 1}^{N} {h}_{i} {s}_{i} \qquad ( 5 - 1 )$$

$$\begin{matrix}{\sum }_{k = 1}^{N} {A}_{m , k} {s}_{k} + {B}_{m} = 0 , & m = 1 , … ,\end{matrix} M \qquad ( 5 - 2 )$$

Formula (5-2) is M linear equations (M is an integer of 1 or more) representing linear equality constraints. sₖ represents a k-th Ising spin (k is an arbitrary integer greater than or equal to 1 and smaller than or equal to N) among the N Ising spins. A_{m,k} represents a linear coefficient multiplied by sₖ, which is the k-th Ising spin, in an m-th linear equation (m is an arbitrary integer greater than or equal to 1 and smaller than or equal to M) among the M linear equations. Bₘ represents a constant term in the m-th linear equation among the M linear equations.

### Algorithm for Solving Problem of Minimizing Augmented Lagrange Function

The Ising problem under a linear equality constraint can be solved by using the augmented Lagrange method. The augmented Lagrange method is a method in which a solution to an Ising problem is acquired under a linear equality constraint by iteratively calculating a solution to a problem of minimizing an augmented Lagrange function while changing a Lagrange multiplier (λ) and a penalty multiplier (μ).

The problem of minimizing the augmented Lagrange function based on the Ising problem under constraints by the M linear equations is expressed as Formula (6).

$${min}_{s ∈ {[ - 1 , 1 ]}^{N}} - \frac{1}{2} {\sum }_{i = 1}^{N} {\sum }_{j = 1}^{N} {J}_{i , j} {s}_{i} {s}_{j} + {\sum }_{i = 1}^{N} {h}_{i} {s}_{i} + {\sum }_{m = 1}^{M} {λ}_{m} ( {\sum }_{k = 1}^{N} {A}_{m , k} {s}_{k} + {B}_{m} ) + {\sum }_{m = 1}^{M} {μ}_{m} ( {\sum }_{k = 1}^{N} {A}_{m , k} {s}_{k} + {B}_{m} ) \qquad ( 6 )$$

λₘ represents an m-th Lagrange multiplier among M Lagrange multipliers (λ) included in the augmented Lagrange function. μₘ represents an m-th penalty multiplier among M penalty multipliers (μ) included in the augmented Lagrange function.

The augmented Lagrange function is a function obtained by adding the objective function of the Ising problem (the first term and the second term in Formula (6)), M Lagrange terms (the third term in Formula (6)), and

M penalty terms (the fourth term in Formula (6)). An m-th Lagrange term among the M Lagrange terms represents a value obtained by multiplying the m-th Lagrange multiplier (λₘ) by a value obtained by substituting the solution into an m-th equation on the left side in Formula (5-2). The M penalty terms correspond to the M linear equations. An m-th penalty term among the M penalty terms represents a value obtained by multiplying the m-th penalty multiplier (μₘ) by a value obtained by substituting the solution into an equation obtained by squaring the m-th equation on the left side in Formula (5-2).

The solving device 10 according to the present embodiment calculates a solution to an Ising problem under a linear equality constraint using an augmented Lagrange method. More specifically, the solving device 10 according to the present embodiment acquires the solution to the Ising problem under the linear equality constraint by iteratively calculating a solution to a problem of minimizing the augmented Lagrange function shown in Formula (6) while changing μₘ and μₘ.

Here, the solving device 10 according to the present embodiment uses an algorithm obtained by improving the SB algorithm as a solving algorithm for acquiring a solution to a problem of minimizing the augmented Lagrange function. Specifically, the solving algorithm according to the present embodiment simulates a time evolution of equations of motion shown in Formulas (7-1) and (7-2).

$$\frac{{dx}_{i}}{dt} = \frac{\partial H}{\partial {y}_{i}} = {Dy}_{i} \qquad ( 7 - 1 )$$

$$\frac{{dy}_{i}}{dt} = \frac{\partial H}{\partial {x}_{i}} = ( p - D - {Kx}_{i}^{2} ) {x}_{i} - {ch}_{i} a + c {\sum }_{j = 1}^{N} {J}_{i , j} {x}_{j} \qquad ( 7 - 2 )$$

H represents a Hamiltonian, and is represented by Formula (8).

$$H = {\sum }_{i = 1}^{N} ( \frac{( D - p ) {x}_{i}^{2}}{2} + \frac{{Kx}_{i}^{4}}{4} + \frac{{Dy}_{i}^{2}}{2} ) + c [ - \frac{1}{2} {\sum }_{i = 1}^{N} {\sum }_{j = 1}^{N} {J}_{i , j} {x}_{i} {x}_{j} + {\sum }_{i = 1}^{N} {h}_{i} {x}_{i} a + {\sum }_{m = 1}^{M} {λ}_{m} ( {\sum }_{i = 1}^{N} {A}_{m , i} {s}_{i} a + {B}_{m} ) + {\sum }_{m = 1}^{M} {{μ}_{m} ( {\sum }_{i = 1}^{N} {A}_{m , i} {s}_{i} + {B}_{m} )}^{2} ] \qquad ( 8 )$$

Similarly to the SB algorithm, the solving algorithm according to the present embodiment simulates a time evolution of motion equations shown in Equations (7-1) and (7-2) using a discrete solution of the symplectic Euler method. In this case, the solving algorithm according to the present embodiment alternately repeats calculations of Formula (9-1) and Formula (9-2).

$${x}_{i} = {x}_{i} + {Dy}_{i} dt \qquad ( 9 - 1 )$$

$${y}_{i} = {y}_{i} + \{ ( p - D - {Kx}_{i}^{2} ) {x}_{i} - {ch}_{i} a + c {\sum }_{j = 1}^{N} {J}_{i , j} {x}_{j} + c {\sum }_{m = 1}^{M} {A}_{m , i} [ \{ {\sum }_{k = 1}^{N} ( 2 {μ}_{m} {A}_{m , k} ) {x}_{k} \} + ( 2 {μ}_{m} {B}_{m} + {λ}_{m} a ) ] \} dt \qquad ( 9 - 2 )$$

Note that H shown in Formula (8) represents a Hamiltonian obtained by adding energy corresponding to the M Lagrange terms and the M penalty terms in the augmented Lagrange function to the Hamiltonian in the SB algorithm. Therefore, an equation for updating the variable yᵢ representing the momentum of the i-th particle shown in Formula (9-2) is an arithmetic equation for adding a constraint term of Formula (10) to the amount of change per unit time of the variable yᵢ in the SB algorithm.

$$c {\sum }_{m = 1}^{M} {A}_{m , i} [ \{ {\sum }_{k = 1}^{N} ( 2 {μ}_{m} {A}_{m , k} ) {x}_{k} \} + ( 2 {μ}_{m} {B}_{m} + {λ}_{m} a ) ] \qquad ( 10 )$$

Then, the algorithm for solving the augmented Lagrange function binarizes each of the values of the N variables xᵢ when a predetermined number of iterations is reached to −1 or 1 using a predetermined threshold (e.g., 0), and outputs the binarized result as a solution to the problem of minimizing the augmented Lagrange function.

As the solving algorithm in the present embodiment, another variation of SB algorithm may be used. For example, as the solving algorithm in the present embodiment, a ballistic SB algorithm or a discrete SB algorithm may be used to calculate a solution to a problem of minimizing the augmented Lagrange function. In this case as well, the solving algorithm according to the present embodiment may update the momentum of the i-th particle using an arithmetic equation for adding the constraint term of Formula (10) to the amount of change per unit time of the variable yᵢ in the ballistic SB algorithm or the discrete SB algorithm.

### Solving Device 10

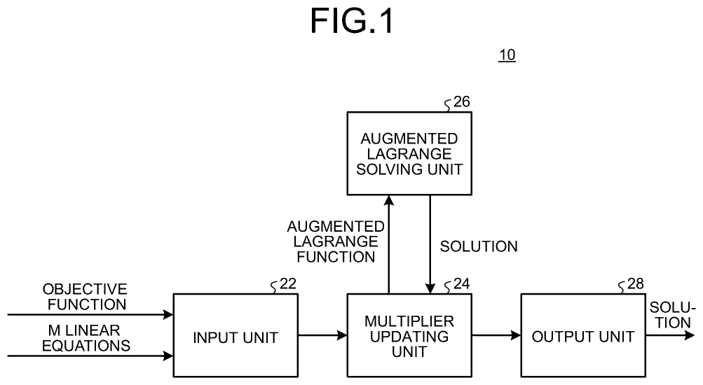

FIG. 1 is a diagram illustrating a functional configuration of the solving device 10 according to the present embodiment.

The solving device 10 according to the present embodiment solves an Ising problem under a linear equality constraint represented by M linear equations. Each of the M linear equations uses N Ising spins included in the Ising problem.

The solving device 10 is implemented by, for example, an information processing device such as a computer, a computer system configured by a plurality of computers or servers communicating with each other via a network, a PC cluster in which a plurality of computers cooperatively perform information processing, or the like. In addition, the solving device 10 may be implemented by an electronic circuit such as a CPU, a microprocessor, a GPU, an FPGA, an ASIC, or a combination of these circuits.

The solving device 10 includes, as a functional configuration, an input unit 22, a multiplier updating unit 24, an augmented Lagrange solving unit 26, and an output unit 28.

The input unit 22 receives an objective function of the Ising problem and M linear equations representing a linear equality constraint. More specifically, the input unit 22 acquires, as the objective function of the Ising problem, N, which is the number of Ising spins, J, which is an interaction matrix, and h, which is an external magnetic field vector. Furthermore, the input unit 22 acquires, as the M linear equations, M representing the number of linear equations, A, which is a matrix representing M×N linear coefficients in the M linear equations, and B, which is a vector representing M constant terms in the M linear equations.

The multiplier updating unit 24 generates an augmented Lagrange function based on the objective function of the Ising problem and the M linear equations. The multiplier updating unit 24 repeats update processing of updating M Lagrange multipliers (λ) and M penalty multipliers (μ) included in the augmented Lagrange function. The multiplier updating unit 24 gives an augmented Lagrange function including the updated M Lagrange multipliers (λ) and M penalty multipliers (μ) to the augmented Lagrange solving unit 26 each time the update processing is performed. Then, the multiplier updating unit 24 acquires a solution to a problem of minimizing the augmented Lagrange function from the augmented Lagrange solving unit 26 each time the update processing is performed.

In the update processing at the first time after receiving the objective function and the M linear equations, the multiplier updating unit 24 sets each of the M Lagrange multipliers (λ) and each of the M penalty multipliers (μ) to initial values. Then, in the update processing at second and subsequent times, the multiplier updating unit 24 updates each of the M Lagrange multipliers (λ) and each of the M penalty multipliers (μ) based on the solution to the problem of minimizing the augmented Lagrange function including the M Lagrange multipliers (λ) and the M penalty multipliers (λ) updated in the update processing at the immediately preceding time. For example, the multiplier updating unit 24 calculates new M Lagrange multipliers (λ) and new M penalty multipliers (μ) by substituting the solution acquired in the update processing at the immediately preceding time and the M Lagrange multipliers (λ) and the M penalty multipliers (μ) used in the immediately preceding update processing into a predetermined arithmetic equation.

The augmented Lagrange solving unit 26 acquires an updated augmented Lagrange function each time the multiplier updating unit 24 performs update processing. The augmented Lagrange solving unit 26 calculates a solution to a problem of minimizing the augmented Lagrange function acquired each time the multiplier updating unit 24 performs update processing. The augmented Lagrange solving unit 26 calculates the solution, for example, by the above-described solving algorithm that alternately repeats calculations of Formula (9-1) and Formula (9-2). Then, the augmented Lagrange solving unit 26 gives the calculated solution to the problem of minimizing the augmented Lagrange function to the multiplier updating unit 24.

The output unit 28 determines whether the update processing has been repeated by the multiplier updating unit 24 until a preset end condition is reached. The output unit 28 may determine that the end condition has been reached, for example, when a predetermined time has elapsed since the start of the process, or when the update processing has been performed a preset number of times since the start of the process. Furthermore, the output unit 28 may determine that the end condition has been reached, for example, when the amount of change between before and after the update in at least one of the M Lagrange multipliers (λ) and the M penalty multipliers (μ) is smaller than or equal to a threshold.

Then, the output unit 28 outputs the solution to the problem of minimizing the augmented Lagrange function after repeating the update processing until the preset end condition is reached as a solution obtained by solving the Ising problem under the linear equality constraint. Note that the output unit 28 may determine whether the solution to the problem of minimizing the augmented Lagrange function after repeating the update processing until the end condition is reached satisfies the linear equality constraint, and output the solution when the solution satisfies the linear equality constraint.

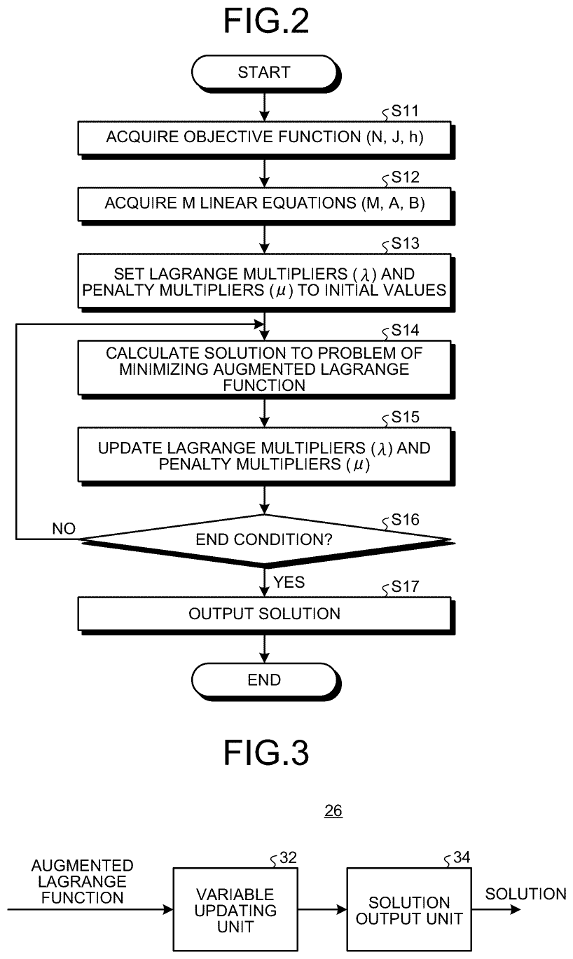

FIG. 2 is a flowchart illustrating a flow of a process performed by the solving device 10. The solving device 10 performs the process in the flow illustrated in FIG. 2.

First, in S11, the solving device 10 acquires an objective function (N, J, h) of an Ising problem. Subsequently, in S12, the solving device 10 receives (acquires) M linear equations (M, A, B) representing a linear equality constraint. Subsequently, in S13, the solving device 10 sets each of M Lagrange multipliers (λ) and each of M penalty multipliers (μ) to initial values.

Subsequently, in S14, the solving device 10 calculates a solution to a problem of minimizing an augmented Lagrange function including the M Lagrange multipliers (λ) and the M penalty multipliers (μ) set to the initial values. Subsequently, in S15, the solving device 10 updates each of the M Lagrange multipliers (λ) and each of the M penalty multipliers (μ) based on the solution to the problem of minimizing the augmented Lagrange function.

Subsequently, in S16, the solving device 10 determines whether a preset end condition has been reached. When the end condition has not been reached (No in S16), the solving device 10 returns the process to S14, and calculates a solution to a problem of minimizing an augmented Lagrange function including the updated M Lagrange multipliers (λ) and M penalty multipliers (μ).

When the end condition is satisfied (Yes in S16), the solving device 10 advances the process to the process to S17. In S17, the solving device 10 outputs the solution to the problem of minimizing the augmented Lagrange function after repeating the update processing until the preset end condition is reached as a solution obtained by solving the Ising problem under the linear equality constraint. The solving device 10 ends this flow when the process ends up to S17.

As described above, the solving device 10 can solve an Ising problem under a linear equality constraint represented by M linear equations.

### Augmented Lagrange Solving Unit 26

FIG. 3 is a diagram illustrating a functional configuration of the augmented Lagrange solving unit 26 according to the present embodiment.

The augmented Lagrange solving unit 26 solves a solution to a problem of minimizing an augmented Lagrange function by using the algorithm for solving the augmented Lagrange function according to the present embodiment.

The augmented Lagrange solving unit 26 includes a variable updating unit 32 and a solution output unit 34 as a functional configuration.

The variable updating unit 32 receives information (e.g., N, J, h, M, A, and B) for defining the augmented Lagrange function from the multiplier updating unit 24. Furthermore, the variable updating unit 32 receives information (e.g., D, K, c, Δt, T, p, and a) indicating coefficients or the like necessary for executing the solving algorithm.

Using the solving algorithm, the variable updating unit 32 alternately updates first variables (xᵢ) and second variables (yᵢ) for the N particles with which the first variables (xᵢ) and the second variables (yᵢ) are associated, sequentially every unit time (Δt) from the initial time (t=0) to the end time (t=T).

The solution output unit 34 outputs a solution to a problem of minimizing an augmented Lagrange function based on the respective first variable (xᵢ) of the N particles at the end time (t=T). For example, the solution output unit 34 calculates values of N Ising spins obtained by binarizing the first variables (xᵢ) to −1 or 1 using a preset threshold (e.g., 0) for the respective N particles at the end time. Then, the solution output unit 34 outputs the calculated values of the N Ising spins as a solution to a problem of minimizing the augmented Lagrange function.

Here, the N particles correspond to N Ising spins in the Ising problem. Each of the first variables (xᵢ) and the second variables (yᵢ) is represented by a real number.

Then, in the update processing for each unit time, the variable updating unit 32 updates the first variable (xᵢ) based on the second variable (yᵢ) for each of the N particles. Furthermore, in the update processing for each unit time, the variable updating unit 32 updates the second variable (yᵢ) based on the first variable (xᵢ) and the constraint term for each of the N particles.

For example, in the update processing for each unit time, the variable updating unit 32 updates the second variable (yᵢ) after updating the first variable (xᵢ) for each of the N particles. Alternatively, in the update processing for each unit time, the variable updating unit 32 may update the first variable (xᵢ) after updating the second variable (yᵢ) for each of the N particles.

In the update processing for each unit time, the variable updating unit 32 calculates a constraint term when updating the second variable (yᵢ). Then, the variable updating unit 32 adds the constraint term to the amount of change per unit time of the second variable (yᵢ).

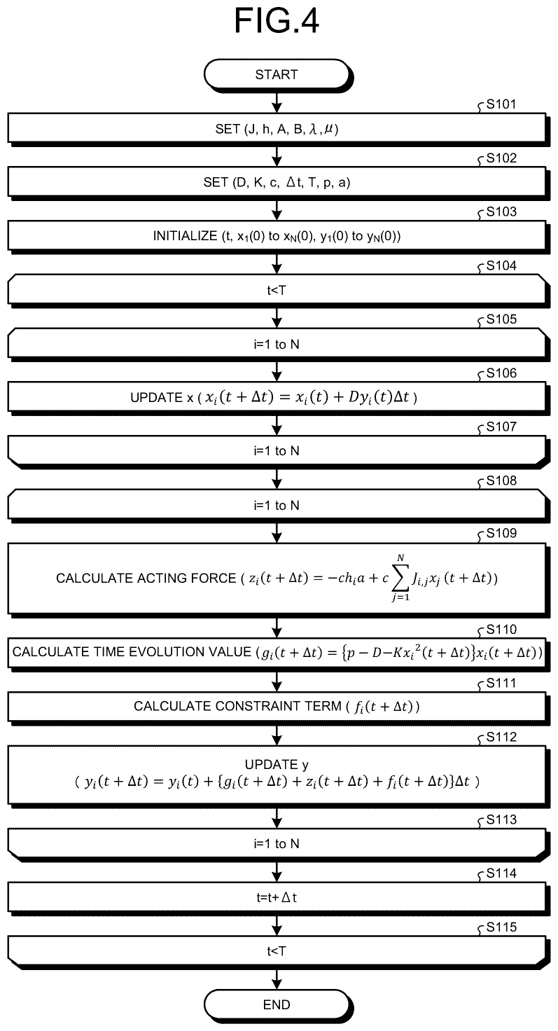

FIG. 4 is a flowchart illustrating a first example of a flow of a process performed by the variable updating unit 32. The variable updating unit 32 executes the process, for example, in the flow illustrated in FIG. 4.

First, in S101, the variable updating unit 32 sets parameters for solving a problem of minimizing the augmented Lagrange function based on the information received from the multiplier updating unit 24. Specifically, the variable updating unit 32 sets J, which is a matrix including N×N coupling coefficients, and h, which is a vector including local magnetic field coefficients representing N local magnetic fields. Furthermore, the variable updating unit 32 sets A representing M×N linear coefficients included in the M linear equations, and B representing M constant terms included in the M linear equations. Furthermore, the variable updating unit 32 sets M Lagrange multipliers (λ) and M penalty multipliers (μ) included in the augmented Lagrange function.

Subsequently, in S102, the variable updating unit 32 sets parameters for executing the solving algorithm. Specifically, the variable updating unit 32 sets D, K, c, Δt representing a unit time, T representing an end time, p, and a. For example, p and a are values that are 0 at t=initial time (e.g., 0) and 1 at t=end time (T). The variable updating unit 32 may set D, K, c, Δt, T, p, and a according to values received from the user, or may set D, K, c, Δt, T, p, and a to predetermined values that is not changeable.

Subsequently, in S103, the variable updating unit 32 initializes the variables. Specifically, the variable updating unit 32 initializes t, which is a variable representing a time, to the initial time (e.g., 0). Furthermore, the variable updating unit 32 substitutes initial values, predetermined fixed values, or random numbers received from the user to the N first variables (x₁(t) to x_{N}(t)) and the N second variables (y₁(t) to y_{N}(t)), respectively.

Subsequently, the variable updating unit 32 repeats loop processing between S104 and S115 until t becomes larger than T. In one-time loop processing, the variable updating unit 32 calculates N first variables (x₁(t+Δt) to x_{N}(t+Δt)) at a target time (t+Δt) based on the N first variables (x₁(t) to x_{N}(t)) at the immediately preceding time (t) and the N second variables (y₁(t) to y_{N}(t)) at the immediately preceding time (t). In addition, in one-time loop processing, the variable updating unit 32 calculates N second variables (y₁(t+Δt) to y_{N}(t+Δt)) at the target time (t+Δt) based on the N first variables (x₁(t+Δt) to x_{N}(t+Δt)) at the target time (t+Δt), the N second variables (y₁(t) to y_{N}(t)) at the immediately preceding time (t), and constraint terms.

Note that the immediately preceding time (t) is a time before the target time (t+Δt) by a unit time (Δt). That is, the variable updating unit 32 sequentially updates the N first variables (x₁(t) to x_{N}(t)) and the N second variables (y₁(t) to y_{N}(t)) every unit time (Δt) from the initial time (t=0) to the end time (t=T) by repeating the loop processing between S104 and S115.

Subsequently, the variable updating unit 32 repeats the loop processing between S105 and S107 while incrementing i by 1 from i=1 to i=N. i is an integer from 1 to N, and is an index representing a processing target among the N particles. In the loop processing between S105 and S107, the variable updating unit 32 executes the processing with an i-th particle among the N particles as a target particle.

In S106, the variable updating unit 32 calculates a first variable (xᵢ(t+Δt)) of the target particle at the target time (t+Δt) by adding, to a first variable (xᵢ(t)) of the target particle at the immediately preceding time (t), a value obtained by multiplying a second variable (yᵢ(t)) of the target particle at the immediately preceding time (t), a predetermined constant (D), and the unit time (Δt). Specifically, the variable updating unit 32 calculates Formula (11).

$${x}_{i} ( t + Δ t ) = {x}_{i} ( t ) + {Dy}_{i} ( t ) Δ t \qquad ( 11 )$$

That is, for each of the N particles, the variable updating unit 32 updates the first variable (xᵢ(t+Δt)) of the target particle at the target time (t+Δt) based on the first variable (xᵢ(t)) of the target particle at the immediately preceding time (t) and the second variable (yᵢ(t)) of the target particle at the immediately preceding time (t).

When the loop processing between S105 and S107 is executed N times, the variable updating unit 32 advances the process to S108.

Subsequently, the variable updating unit 32 repeats the loop processing between S108 and S113 while incrementing i by 1 from i=1 to i=N.

In S109, the variable updating unit 32 calculates an acting force (zᵢ(t+Δt)) based on the respective first variables (x₁(t+Δt) to x_{N}(t+Δt)) of the N particles at the target time (t+Δt) and action coefficients. The action coefficients are coupling coefficients included in J and local magnetic field coefficients included in h. The coupling coefficient is determined for each set of the target particle and each of the N particles. Specifically, the variable updating unit 32 calculates Formula (12).

$${z}_{i} ( t + Δ t ) = - {ch}_{i} a + c {\sum }_{j = 1}^{N} {J}_{i , j} {x}_{j} ( t + Δ t ) \qquad ( 12 )$$

Subsequently, in S110, the variable updating unit 32 calculates a time evolution value (gᵢ(t+Δt)) based on D and K, which are constants, p, which is a value increasing over time, and the first variable (x₁(t+Δt)) of the target particle at the target time (t+Δt). Specifically, the variable updating unit 32 calculates Formula (13).

$${g}_{i} ( t + Δ t ) = \{ p - D - {Kx}_{i}^{2} ( t + Δ t ) \} {x}_{i} ( t + Δ t ) \qquad ( 13 )$$

Subsequently, in S111, the variable updating unit 32 calculates a constraint term (fᵢ(t+Δt)). Specifically, the variable updating unit 32 calculates Formula (14).

$${f}_{i} ( t + Δ t ) = c {\sum }_{m = 1}^{M} {A}_{m , i} [ \{ {\sum }_{k = 1}^{N} 2 {μ}_{m} {A}_{m , k} {x}_{k} ( t + Δ t ) \} + ( 2 {μ}_{m} {B}_{m} + {λ}_{m} a ) ] \qquad ( 14 )$$

Subsequently, in S112, the variable updating unit 32 calculates a second variable (yᵢ(t+Δt)) of the target particle at the target time (t+Δt) by adding, to a second variable (yᵢ(t)) of the target particle at the immediately preceding time (t), a value obtained by multiplying the unit time (Δt) by a value obtained by adding the time evolution value (gᵢ(t+Δt)), the acting force (zᵢ(t+Δt)), and the constraint term (fᵢ(t+Δt)). Specifically, the variable updating unit 32 calculates Formula (15).

$${y}_{i} ( t + Δ t ) = {y}_{i} ( t ) + \{ {g}_{i} ( t + Δ t ) + {z}_{i} ( t + Δ t ) + {f}_{i} ( t + Δ t ) \} Δ t \qquad ( 15 )$$

By executing the loop processing between S108 and S113 N times as described above, the variable updating unit 32 updates the second variable (yᵢ(t+Δt)) at the target time (t+Δt) for each of the N particles based on the N first variables (x₁(t+Δt) to x_{N}(t+Δt)) at the target time (t+Δt), the second variable (yᵢ(t)) of the target particle at the immediately preceding time (t), and the constraint term.

When the loop processing between S108 and S113 is executed N times, the variable updating unit 32 advances the process to S114.

In S114, the variable updating unit 32 adds the unit time (Δt) to each of the immediately preceding time (t) and the target time (t+Δt) to update the immediately preceding time (t) and the target time (t+Δt). In S115, the variable updating unit 32 repeats the processing from S105 to S114 until t exceeds the end time (T). Then, when t becomes larger than the end time (T), the variable updating unit 32 ends this flow.

By executing the above-described processing of

S101 to S115, the variable updating unit 32 can calculate N first variables (x₁(t) to x_{N}(t)) and N second variables (y₁(t) to y_{N}(t)) at the end time (t=T) by executing calculations according to the solving algorithm.

Then, the solution output unit 34 calculates a value of a corresponding Ising spin according to the sign of the first variable (xᵢ(T)) at the end time (t=T) for each of the N particles. For example, the solution output unit 34 sets the corresponding Ising spin to −1 when the sign of the first variable (xᵢ(T)) at the end time (t=T) is negative, and sets the corresponding Ising spin to 1 when the sign of the first variable (xᵢ(T)) at the end time (t=T) is positive. Then, the solution output unit 34 outputs the calculated values of the N Ising spins.

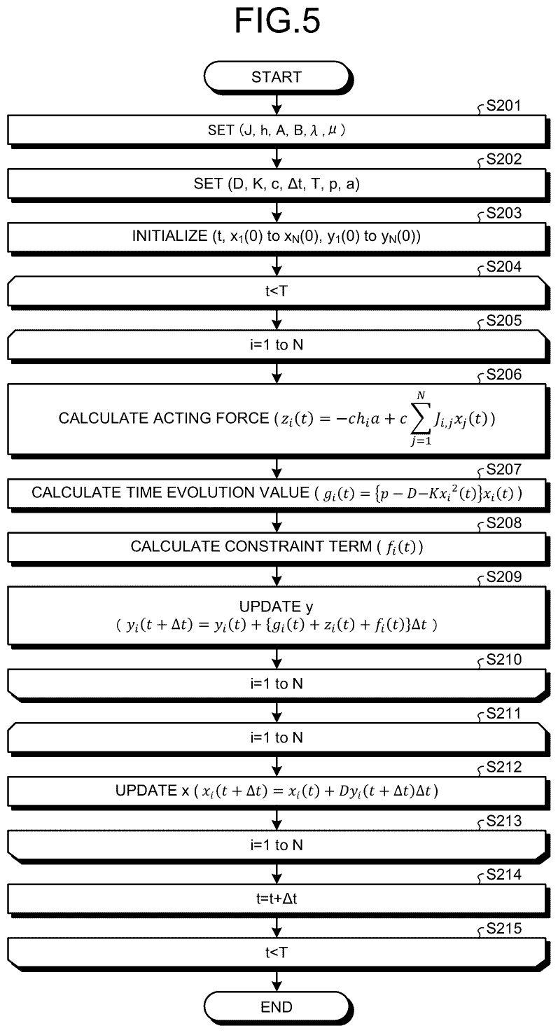

FIG. 5 is a flowchart illustrating a second example of a flow of a process performed by the variable updating unit 32. When solving a problem of minimizing an augmented Lagrange function using the solving algorithm, the variable updating unit 32 may execute the process in the flow illustrated in FIG. 5 instead of the flow illustrated in FIG. 4.

First, in S201, S202, and S203, the variable updating unit 32 executes the same processing as S101, S102, and S103 of the first example illustrated in FIG. 4.

Subsequently, the variable updating unit 32 repeats loop processing between S204 and S215 until t becomes larger than T. In one-time loop processing, the variable updating unit 32 calculates N second variables (y₁(t+Δt) to y (t+Δt)) at a target time (t+Δt) based on the N first variables (x₁(t) to x_{N}(t)) at the immediately preceding time (t), the N second variables (y₁(t) to y_{N}(t)) at the immediately preceding time (t), and constraint terms. In addition, in one-time loop processing, the variable updating unit 32 calculates N first variables (x₁(t+Δt) to x_{N}(t+Δt)) at the target time (t+Δt) based on the N first variables (x₁(t) to x_{N}(t)) at the immediately preceding time (t) and the N second variables (y₁(t+Δt) to y_{N}(t+Δt)) at the target time (t+Δt).

Subsequently, the variable updating unit 32 repeats the loop processing between S205 and S210 while incrementing i by 1 from i=1 to i=N. In the loop processing between S205 and S210, the variable updating unit 32 executes the processing with an i-th particle among the N particles as a target particle.

In S206, the variable updating unit 32 calculates an acting force (zᵢ(t)) based on the respective first variable (x₁(t) to x_{N}(t)) of the N particles at the immediately preceding time (t) and action coefficients. Specifically, the variable updating unit 32 calculates Formula (16).

$${z}_{i} ( t ) = - {ch}_{i} a + c {\sum }_{j = 1}^{N} {J}_{i , j} {x}_{j} ( t ) \qquad ( 16 )$$

Subsequently, in S207, the variable updating unit 32 calculates a time evolution value (gᵢ(t)) based on D, K, p, and the first variable (x₁(t)) of the target particle at the immediately preceding time (t). Specifically, the variable updating unit 32 calculates Formula (17).

$${g}_{i} ( t ) = \{ p - D - {Kx}_{i}^{2} ( t ) \} {x}_{i} ( t ) \qquad ( 17 )$$

Subsequently, in S208, the variable updating unit 32 calculates a constraint term (fᵢ(t)). Specifically, the variable updating unit 32 calculates Formula (18).

$${f}_{i} ( t ) = c {\sum }_{m = 1}^{M} {A}_{m , i} [ \{ {\sum }_{k = 1}^{N} 2 {μ}_{m} {A}_{m , k} {x}_{k} ( t ) \} + ( 2 {μ}_{m} {B}_{m} + {λ}_{m} a ) ] \qquad ( 18 )$$

Subsequently, in S209, the variable updating unit 32 calculates a second variable (yᵢ(t+Δt)) of the target particle at the target time (t+Δt) by adding, to a second variable (yᵢ(t)) of the target particle at the immediately preceding time (t), a value obtained by multiplying the unit time (Δt) by a value obtained by adding the time evolution value (gᵢ(t)), the acting force (zᵢ(t)), and the constraint term (fᵢ(t)). Specifically, the variable updating unit 32 calculates Formula (19).

$${y}_{i} ( t + Δ t ) = {y}_{i} ( t ) + \{ {g}_{i} ( t ) + {z}_{i} ( t ) + {f}_{i} ( t ) \} Δ t \qquad ( 19 )$$

By executing the loop processing between S205 and S210 N times as described above, the variable updating unit 32 updates the second variable (yᵢ(t+Δt)) at the target time (t+Δt) for each of the N particles based on the N first variables (x₁(t) to x_{N}(t)) at the immediately preceding time (t), the second variable (yᵢ(t)) of the target particle at the immediately preceding time (t), and the constraint term.

When the loop processing between S205 and S210 is executed N times, the variable updating unit 32 advances the process to S211.

Subsequently, the variable updating unit 32 repeats the loop processing between S211 and S213 while incrementing i by 1 from i=1 to i=N.

In S212, the variable updating unit 32 calculates a first variable (xᵢ(t+Δt)) of the target particle at the target time (t+Δt) by adding, to a first variable (xᵢ(t)) of the target particle at the immediately preceding time (t), a value obtained by multiplying a second variable (yᵢ(t+Δt)) of the target particle at the subject time (t+Δt), a predetermined constant (D), and the unit time (Δt). Specifically, the variable updating unit 32 calculates Formula (20).

$${x}_{i} ( t + Δ t ) = {x}_{i} ( t ) + {Dy}_{i} ( t + Δ t ) Δ t \qquad ( 20 )$$

That is, for each of the N particles, the variable updating unit 32 updates the first variable (xᵢ(t+Δt)) of the target particle at the target time (t+Δt) based on the first variable (xᵢ(t)) of the target particle at the immediately preceding time (t) and the second variable (yᵢ(t)) of the target particle at the immediately preceding time (t).

When the loop processing between S211 and S213 is executed N times, the variable updating unit 32 advances the process to S214.

In S214, the variable updating unit 32 adds the unit time (Δt) to each of the immediately preceding time (t) and the target time (t+Δt) to update the immediately preceding time (t) and the target time (t+Δt). In S215, the variable updating unit 32 repeats the processing from S211 to S214 until t exceeds the end time (T). Then, when t becomes larger than the end time (T), the variable updating unit 32 ends this flow.

By executing the above-described processing of S201 to S215, the variable updating unit 32 can calculate N first variables (x₁(t) to x_{N}(t)) and N second variables (y₁(t) to y_{N}(t)) at the end time (t=T) by executing calculations according to the solving algorithm.

Then, the solution output unit 34 calculates a value of a corresponding Ising spin according to the sign of the first variable (xᵢ(T)) at the end time (t=T) for each of the N particles. For example, the solution output unit 34 sets the corresponding Ising spin to −1 when the sign of the first variable (xᵢ(T)) at the end time (t=T) is negative, and sets the corresponding Ising spin to 1 when the sign of the first variable (xᵢ(T)) at the end time (t=T) is positive. Then, the solution output unit 34 outputs the calculated values of the N Ising spins.

Note that the variable updating unit 32 may execute a calculation of Formula (21) prior to the loop processing of S104 to S115 in the flow of FIG. 4 or the loop processing of S204 to S215 in the flow of FIG. 5.

$$\begin{matrix}{r}_{i} = {\sum }_{m = 1}^{M} {A}_{m , i} 2 {μ}_{m} {B}_{m} , & i = 1 , 2 , … , N\end{matrix} \qquad ( 21 )$$

In the flow of FIG. 4, when the calculation of Formula (21) is executed first, the variable updating unit 32 executes the calculation of Formula (22) in S111.

$${f}_{i} ( t ) = c [ {\sum }_{m = 1}^{M} {A}_{m , i} [ \{ {\sum }_{k = 1}^{N} 2 {μ}_{m} {A}_{m , k} {x}_{k} ( t ) \} + {λ}_{m} a ] ] + {cr}_{i} \qquad ( 22 )$$

In addition, in the flow of FIG. 5, when the calculation of Formula (21) is executed first, the variable updating unit 32 executes the calculation of Formula (23) in S208.

$${f}_{i} ( t + Δ t ) = c [ {\sum }_{m = 1}^{M} {A}_{m , i} [ \{ {\sum }_{k = 1}^{N} 2 {μ}_{m} {A}_{m , k} {x}_{k} ( t + Δ t ) \} + {λ}_{m} a ] ] + {cr}_{i} \qquad ( 23 )$$

By executing such processing, the variable updating unit 32 can reduce the amount of calculations in the loop, thereby reducing the total amount of calculations according to the solving algorithm.

The solving device 10 according to the present embodiment as described above can solve an Ising problem under a linear equality constraint by using the augmented Lagrange solving unit 26 for solving a problem of minimizing an augmented Lagrange function. Similarly to the SB algorithm, the augmented Lagrange solving unit 26 minimizes an augmented Lagrange function by simulating a time evolution of equations of motion using a discrete solution of the symplectic Euler method, thereby making it possible to quickly and easily obtaining a solution with high accuracy. Therefore, the solving device 10 according to the present embodiment can quickly and easily obtain a highly accurate solution to an Ising problem under a linear equality constraint without performing an equation deformation to find a new Ising problem equal to a function obtained by adding a constant to an augmented Lagrange function.

In addition, for example, in a case where J, which is a coupling matrix of an Ising problem to be solved, is a sparse matrix with many zero elements, there is a high possibility that it will no longer be a sparse matrix if the equation is transformed. Therefore, in a case where an Ising problem is solved by transforming the equation, the amount of calculations required by the Ising machine becomes very large even though the sparse matrix is handled. However, since the solving device 10 according to the present embodiment solves a problem of minimizing an augmented Lagrange function using a sparse matrix as it is, the amount of calculations can be reduced. In addition, since the solving device 10 according to the present embodiment solves a problem of minimizing an augmented Lagrange function using a sparse matrix as it is, the amount of information representing the problem can be reduced, and the memory usage can also be reduced.

### Hardware Configuration

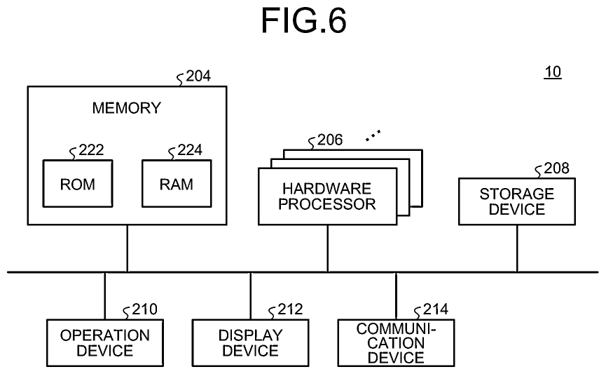

FIG. 6 is a diagram illustrating a hardware configuration of the solving device 10. As an example, the solving device 10 is realized by a hardware configuration similar to that of a general computer (an information processing device) as illustrated in FIG. 6. The solving device 10 may be realized by a single computer or server as illustrated in FIG. 6, or may be realized by a plurality of computers or servers operating in cooperation with each other. In addition, the solving device 10 may include a dedicated hardware circuit as a part thereof.

The solving device 10 includes a memory 204, one or more hardware processors 206, a storage device 208, an operation device 210, a display device 212, and a communication device 214. These units are connected to each other by a bus.

The memory 204 includes, for example, a ROM 222 and a RAM 224. The ROM 222 unrewritably stores programs, various kinds of setting information, and the like used for controlling the solving device 10. The RAM 224 is a volatile storage medium such as a synchronous dynamic random access memory (SDRAM). The RAM 224 functions as a work area for the one or more hardware processors 206.

The one or more hardware processors 206 are connected to the memory 204 (the ROM 222 and the RAM 224) via the bus. Each of the one or more hardware processors 206 may be, for example, a central processing unit (CPU) or a hardware circuit for calculation.

The one or more hardware processors 206 execute various types of processing in cooperation with various programs stored in advance in the ROM 222 or the storage device 208 using a predetermined area of the RAM 224 as a work area, and control the operations of the units constituting the solving device 10 over all. Furthermore, the one or more hardware processors 206 control the operation device 210, the display device 212, the communication device 214, etc. in cooperation with the programs stored in advance in the ROM 222 or the storage device 208.

The storage device 208 is a rewritable recording device such as a semiconductor storage medium such as a flash memory or a magnetically or optically recordable storage medium. The storage device 208 stores programs, various kinds of setting information, and the like used for controlling the solving device 10.

The operation device 210 is an input device such as a mouse and a keyboard. The operation device 210 receives information input by an operation from the user, and outputs the received information to the one or more hardware processors 206.

The display device 212 displays information to the user. The display device 212 receives information and the like from the one or more hardware processors 206, and displays the received information. When information is output to the communication device 214, the storage device 208, or the like, the display device 212 may not be included in the solving device 10. The communication device 214 communicates with an external device to transmit and receive information via a network or the like.

The program executed by the solving device 10 according to the present embodiment is recorded and provided as a file in an installable format or an executable format in a computer-readable recording medium such as a CD-ROM, a flexible disk (FD), a CD-R, or a digital versatile disk (DVD).

In addition, the program executed by the solving device 10 according to the present embodiment may be stored in a computer connected to a network such as the Internet, and provided by being downloaded via the network. In addition, the program executed by the solving device 10 according to the present embodiment may be provided or distributed via a network such as the Internet. In addition, the program executed by the solving device 10 according to the present embodiment may be provided by being pre-installed in the ROM or the like.

The program for causing the information processing device to function as the solving device 10 has a module configuration including, for example, an input module, a multiplier updating module, an augmented Lagrange solving module (a variable updating module and a solution outputting module), and an output module. This program is executed by the one or more hardware processors 206, whereby each module is loaded into the RAM 224 of the memory 204, and causes the one or more hardware processors 206 to function as the input unit 22, the multiplier updating unit 24, the augmented Lagrange solving unit 26 (the variable updating unit 32 and the solution output unit 34), and the output unit 28. Note that some or all of these configurations may be configured by hardware.

Although some embodiments of the present invention have been described, these embodiments have been presented as examples, and are not intended to limit the scope of the invention. These novel embodiments can be implemented in various other forms, and various omissions, substitutions, and changes can be made without departing from the gist of the invention. These embodiments and modifications thereof fall within the scope and gist of the invention, and fall within the scope of the invention set forth in the claims and equivalents thereof.

What is claimed is:

1. A solving device solving an Ising problem under a linear equality constraint represented by M linear equations using N Ising spins included in the Ising problem, M being an integer of 1 or more, N being an integer of 2 or more, the solving device comprising:
a hardware processor configured to function as:
an input unit that receives an objective function of the Ising problem and the M linear equations;
a multiplier updating unit that repeats update processing of updating M Lagrange multipliers and M penalty multipliers included in an augmented Lagrange function based on the objective function and the M linear equations;
an augmented Lagrange solving unit that calculates a solution to a problem of minimizing the augmented Lagrange function including the M Lagrange multipliers and the M penalty multipliers updated each time the update processing is performed; and
an output unit that outputs a solution to a problem of minimizing the augmented Lagrange function after the update processing is repeated until a preset end condition is reached, as a solution obtained by solving the Ising problem under the linear equality constraint, wherein
the augmented Lagrange solving unit includes:
a variable updating unit that alternately updates first variables and second variables sequentially for each unit time from an initial time to an end time for each of N virtual particles with which the first variables and the second variables are associated, respectively; and
a solution output unit that outputs a solution to a problem of minimizing the augmented Lagrange function based on the respective first variables of the N particles at the end time,
the N particles correspond to the N Ising spins,
in the update processing for the each unit time, the variable updating unit:
updates the first variable based on the second variable for each of the N particles; and
updates the second variable based on the first variable and a constraint term for each of the N particles, and
the constraint term is represented by Formula (101):
$$c {\sum }_{m = 1}^{M} {A}_{m , i} [ \{ {\sum }_{k = 1}^{N} ( 2 {μ}_{m} {A}_{m , k} ) {x}_{k} \} + ( 2 {μ}_{m} {B}_{m} + {λ}_{m} a ) ] \qquad ( 101 )$$
where a is a predetermined coefficient,
c is a predetermined coefficient,
i represents an integer from 1 to N,
k represents an integer from 1 to N,
m represents an integer from 1 to M,
xₖ is the first variable corresponding to a k-th particle among the N particles,
A_{m,k} represents a linear coefficient multiplied by a k-th Ising spin in an m-th linear equation among the M linear equations, and
Bₘ represents a constant term in the m-th linear equation,
λₘ represents an m-th Lagrange multiplier among the M Lagrange multipliers, and
μm represents an m-th penalty multiplier among the M penalty multipliers.

2. The solving device according to claim 1, wherein the Ising problem is represented by Formula (102):
$${min}_{s ∈ {\{ - 1 , 1 \}}^{N}} - \frac{1}{2} {\sum }_{i = 1}^{N} {\sum }_{j = 1}^{N} {J}_{i , j} {s}_{i} {s}_{j} + {\sum }_{i = 1}^{N} {h}_{i} {s}_{i} \qquad ( 102 )$$
where i represents an integer from 1 to N,
j represents an integer from 1 to N,
sᵢ is −1 or 1, and represents an i-th Ising spin among the N Ising spins,
sⱼ is −1 or 1, and represents a j-th Ising spin among the N Ising spins,
J_{i,j} is a coupling coefficient in an i-th row and a j-th column included in a predetermined matrix including N×N coupling coefficients, and
hᵢ is an i-th local magnetic field coefficient included in a predetermined vector including N local magnetic field coefficients.

3. The solving device according to claim 2, wherein the M linear equations are expressed by Formula (103):
$${\sum }_{k = 1}^{N} {A}_{m , k} {s}_{k} + {B}_{m} = 0 , m = 1 , … , M . \qquad ( 103 )$$

4. The solving device according to claim 3, wherein
the problem of minimizing the augmented Lagrange function is expressed by Formula (104):
$${min}_{s ∈ {\{ - 1 , 1 \}}^{N}} - \frac{1}{2} {\sum }_{i = 1}^{N} {\sum }_{j = 1}^{N} {J}_{i , j} {s}_{i} {s}_{j} + {\sum }_{i = 1}^{N} {h}_{i} {s}_{i} + {\sum }_{m = 1}^{M} {λ}_{m} ( {\sum }_{k = 1}^{N} {A}_{m , k} {s}_{k} + {B}_{m} ) + {\sum }_{m = 1}^{M} {{μ}_{m} ( {\sum }_{k = 1}^{N} {A}_{m , k} {s}_{k} + {B}_{m} )}^{2} . \qquad ( 104 )$$

5. The solving device according to claim 4, wherein
the multiplier updating unit:
in the update processing at a first time after receiving the objective function and the M linear equations, sets each of the M Lagrange multipliers and each of the M penalty multipliers to initial values, and
in the update processing at second and subsequent times, updates each of the M Lagrange multipliers and each of the M penalty multipliers based on a solution to a problem of minimizing the augmented Lagrange function including the M Lagrange multipliers and the M penalty multipliers that are updated in the update processing at an immediately preceding time.

6. The solving device according to claim 4, wherein
in the update processing for the each unit time, the variable updating unit updates the second variable after updating the first variable for each of the N particles.

7. The solving device according to claim 4, wherein
in the update processing for the each unit time, the variable updating unit updates the first variable after updating the second variable for each of the N particles.

8. The solving device according to claim 6, wherein
in the update processing for the each unit time, the variable updating unit calculates the first variable at a target time for each of the N particles, by adding a value obtained by multiplying the second variable, a predetermined constant, and the unit time to the first variable at an immediately preceding time earlier than the target time by the unit time.

9. The solving device according to claim 8, wherein
in the update processing for the each unit time, the variable updating unit:
for each of the N particles,
calculates an acting force based on the first variable for each of the N particles and an action coefficient determined by the objective function for each set of a target particle and each of the N particles;
calculates a time evolution value obtained by multiplying a value determined based on a function that increases over time by the first variable of the target particle; and
calculates the second variable at the target time by adding a value obtained by multiplying the unit time by a value obtained by adding the acting force, the time evolution value, and the constraint term to the second variable at the immediately preceding time.

10. The solving device according to claim 9, wherein
the variable updating unit calculates the first variable of an i-th particle corresponding to the i-th Ising spin among the N Ising spins at the target time using Formula (105-1) or Formula (105-2):
$${x}_{i} ( t + Δ t ) = {x}_{i} ( t ) + {Dy}_{i} ( t ) Δ t \qquad ( 105 - 1 )$$
$${x}_{i} ( t + Δ t ) = {x}_{i} ( t ) + {Dy}_{i} ( t + Δ t ) Δ t \qquad ( 105 - 2 )$$
where D is a predetermined constant,
Δt is the unit time,
t is the immediately preceding time,
t+Δt is the target time,
xᵢ(t) is the first variable of the i-th particle at the immediately preceding time,
yᵢ(t) is the second variable of the i-th particle at the immediately preceding time,
xᵢ(t+Δt) is the first variable of the i-th particle at the target time, and
yᵢ(t+Δt) is the second variable of the i-th particle at the target time.

11. The solving device according to claim 10, wherein
the variable updating unit calculates the second variable of the i-th particle at the target time using Formula (106-1) or Formula (106-2):
$${y}_{i} ( t + Δ t ) = {y}_{i} ( t ) + \{ {g}_{i} ( t + Δ t ) + {z}_{i} ( t + Δ t ) + {f}_{i} ( t + Δ t ) \} Δ t \qquad ( 106 - 1 )$$
$${y}_{i} ( t + Δ t ) = {y}_{i} ( t ) + \{ {g}_{i} ( t ) + {z}_{i} ( t ) + {f}_{i} ( t ) \} Δ t \qquad ( 106 - 2 )$$
where zᵢ(t) and zᵢ(t+Δt) are the acting forces,
gᵢ(t) and gᵢ(t+Δt) are the time evolution values, and
fᵢ(t) and fᵢ(t+Δt) are the constraint terms.

12. The solving device according to claim 11, wherein
zᵢ(t) and zᵢ(t+Δt) are represented by Formula (107-1) or Formula (107-2):
$${z}_{i} ( t + Δ t ) = - {ch}_{i} a + c {\sum }_{j = 1}^{N} {J}_{i , j} {x}_{j} ( t + Δ t ) \qquad ( 107 - 1 )$$
$${z}_{i} ( t ) = - {ch}_{i} a + c {\sum }_{j = 1}^{N} {J}_{i , j} {x}_{j} ( t ) \qquad ( 107 - 2 )$$
where xⱼ(t) is the first variable at the immediately preceding time of a j-th particle corresponding to the j-th Ising spin among the N Ising spins, and
xⱼ(t+Δt) is the first variable of the j-th particle at the target time.

13. The solving device according to claim 12, wherein
fᵢ(t) and fᵢ(t+Δt) are represented by Formula (108-1) or Formula (108-2):
$${f}_{i} ( t + Δ t ) = c {\sum }_{m = 1}^{M} {A}_{m , i} [ \{ {\sum }_{k = 1}^{N} 2 {μ}_{m} {A}_{m , k} {x}_{k} ( t + Δ t ) \} + ( 2 {μ}_{m} {B}_{m} + {λ}_{m} a ) ] \qquad ( 108 - 1 )$$
$${f}_{i} ( t ) = c {\sum }_{m = 1}^{M} {A}_{m , i} [ \{ {\sum }_{k = 1}^{N} 2 {μ}_{m} {A}_{m , k} {x}_{k} ( t ) \} + ( 2 {μ}_{m} {B}_{m} + {λ}_{m} a ) ] . \qquad ( 108 - 2 )$$

14. The solving device according to claim 13, wherein
gᵢ(t) and gᵢ(t+Δt) are represented by Formula (109-1) or Formula (109-2):
$${g}_{i} ( t + Δ t ) = \{ p - D - {Kx}_{i}^{2} ( t + Δ t ) \} {x}_{i} ( t + Δ t ) \qquad ( 109 - 1 )$$
$${g}_{i} ( t ) = \{ p - D - {Kx}_{i}^{2} ( t ) \} {x}_{i} ( t ) . \qquad ( 109 - 2 )$$

15. The solving device according to claim 12, wherein
the variable updating unit executes Formula (110) prior to executing a constraint of the second variable at the initial time, and
$${r}_{i} = {\sum }_{m = 1}^{M} {A}_{m , i} 2 {μ}_{m} {B}_{m} , i = 1 , 2 , … , N \qquad ( 110 )$$
fᵢ(t) and fᵢ (t+Δt) are represented by Formula (111-1) or Formula (111-2):
$${f}_{i} ( t ) = c [ {\sum }_{m = 1}^{M} {A}_{m , i} [ \{ {\sum }_{k = 1}^{N} 2 {μ}_{m} {A}_{m , k} {x}_{k} ( t ) \} + {λ}_{m} a ] ] + {cr}_{i} \qquad ( 111 - 1 )$$
$${f}_{i} ( t + Δ t ) = c [ {\sum }_{m = 1}^{M} {A}_{m , i} [ \{ {\sum }_{k = 1}^{N} 2 {μ}_{m} {A}_{m , k} {x}_{k} ( t + Δ t ) \} + {λ}_{m} a ] ] + {cr}_{i} . \qquad ( 111 - 2 )$$

16. A solving device solving a problem of minimizing an augmented Lagrange function based on an objective function of an Ising problem defined by N Ising spins and M linear equations, M being an integer of 1 or more, N being an integer of 2 or more, M being an integer of 1 or more, the solving device comprising:
a hardware processor configured to function as:
a variable updating unit that alternately updates first variables and second variables sequentially for each unit time from an initial time to an end time for each of N virtual particles with which the first variables and the second variables are associated, respectively; and
a solution output unit that outputs a solution to a problem of minimizing the augmented Lagrange function based on the respective first variables of the N particles at the end time, wherein
the N particles correspond to the N Ising spins,
in the update processing for the each unit time, the variable updating unit:
updates the first variable based on the second variable for each of the N particles; and
updates the second variable based on the first variable and a constraint term for each of the N particles, and
the constraint term is represented by Formula (101):
$$c {\sum }_{m = 1}^{M} {A}_{m , i} [ \{ {\sum }_{k = 1}^{N} ( 2 {μ}_{m} {A}_{m , k} ) {x}_{k} \} + ( 2 {μ}_{m} {B}_{m} + {λ}_{m} a ) ] \qquad ( 101 )$$
where a is a predetermined coefficient,
c is a predetermined coefficient,
i represents an integer from 1 to N,
k represents an integer from 1 to N,
m represents an integer from 1 to M,
xₖ is the first variable corresponding to a k-th particle among the N particles,
A_{m, k} represents a linear coefficient multiplied by a k-th Ising spin in an m-th linear equation among the M linear equations, and
Bₘ represents a constant term in the m-th linear equation,
λₘ represents an m-th Lagrange multiplier among M Lagrange multipliers included in the augmented Lagrange function, and
μm represents an m-th penalty multiplier among M penalty multipliers included in the augmented Lagrange function.

17. A computer program product having a non-transitory computer readable medium including programmed instructions that are stored thereon and that cause an information processing device to function as a solving device configured to solve an Ising problem under a linear equality constraint represented by M linear equations using N Ising spins included in the Ising problem, M being an integer of 1 or more, N being an integer of 2 or more,
wherein the instructions cause the information processing device to function as:
an input unit that receives an objective function of the Ising problem and the M linear equations;
a multiplier updating unit that repeats update processing of updating M Lagrange multipliers and M penalty multipliers included in an augmented Lagrange function based on the objective function and the M linear equations;
an augmented Lagrange solving unit that calculates a solution to a problem of minimizing the augmented Lagrange function including the M Lagrange multipliers and the M penalty multipliers updated each time the update processing is performed; and
an output unit that outputs a solution to a problem of minimizing the augmented Lagrange function after the update processing is repeated until a preset end condition is reached, as a solution obtained by solving the Ising problem under the linear equality constraint,
the augmented Lagrange solving unit includes:
a variable updating unit that alternately updates first variables and second variables sequentially for each unit time from an initial time to an end time for each of N virtual particles with which the first variables and the second variables are associated, respectively; and
a solution output unit that outputs a solution to a problem of minimizing the augmented Lagrange function based on the respective first variables of the N particles at the end time,
the N particles correspond to the N Ising spins,
in the update processing for the each unit time, the variable updating unit:
updates the first variable based on the second variable for each of the N particles; and
updates the second variable based on the first variable and a constraint term for each of the N particles, and
the constraint term is represented by Formula (101):
$$c {\sum }_{m = 1}^{M} {A}_{m , i} [ \{ {\sum }_{k = 1}^{N} ( 2 {μ}_{m} {A}_{m , k} ) {x}_{k} \} + ( 2 {μ}_{m} {B}_{m} + {λ}_{m} a ) ] \qquad ( 101 )$$
where a is a predetermined coefficient,
c is a predetermined coefficient,
i represents an integer from 1 to N,
k represents an integer from 1 to N,
m represents an integer from 1 to M,
xₖ is the first variable corresponding to a k-th particle among the N particles,
A_{m,k} represents a linear coefficient multiplied by a k-th Ising spin in an m-th linear equation among the M linear equations, and
Bₘ represents a constant term in the m-th linear equation,
λₘ represents an m-th Lagrange multiplier among the M Lagrange multipliers, and
μₘ represents an m-th penalty multiplier among the M penalty multipliers.
